(19) United States
(12) Patent Application Publication
(10) Pub. No.: US 2006/0107636 A1
(43) Pub. Date: May 25, 2006

(54) Atmospheric filter, method and apparatus

(76) Inventor: Kenneth Lee Gage, Glendale, AZ (US)

Correspondence Address: KENNETH LEE GAGE, 6154 WEST ECHO LANE, GLENDALE, AZ, 85302, US

(21) Appl. No.: 10/993,379

(22) Filed: Nov. 19, 2004

(51) Int. Cl. B01D 50/00

(52) U.S. Cl. 55/385.3

(57) ABSTRACT

According to one aspect of the inventions there is provided a filter for removing pollutants from the atmosphere wherein the filter is connected to a vehicle. The filter comprising: a filter material for removing pollutants from the atmosphere to create filtered air; and a housing for: holding the filter material; channeling air from the atmosphere through the filter material; channeling filtered air back into the atmosphere; and providing attachment means for attaching the filter to the vehicle. A method for removing the pollutants from the atmosphere comprising: connecting a filter to a vehicle. The filter comprising: a filter material for removing pollutants from the atmosphere to create filtered air; and a housing connected to the vehicle for: holding the filter material; channeling air from the atmosphere through the filter material; channeling filtered air back into the atmosphere; and providing attachment means for attaching the filter to the vehicle. The method also comprising operating the vehicle such that air from the atmosphere flows through the filter.

### BACKGROUND OF THE INVENTION

1. Field

The invention relates to filtering the atmosphere. More specifically, the invention relates to filtering the atmosphere using a filter attached to a vehicle.

2. Related Art

Pollutants are introduced into our atmosphere daily. Some pollutants are introduced into the atmosphere from a man-made operation such as the chemicals and particles from a factory or an automobile. Others pollutants come from natural causes such as the discharges of smoke and ash from wild fires or the discharge of dust into the air from wind storms.

Humanity recognizes that clean clear air is very important for a healthy life. Enormous bodies of legislation and organizations to enforce the legislation have been created to manage our environment to include the air in our atmosphere. Manufacturers are burdened with restrictions on allowable pollutants that they may introduce into the air. Automobile manufacturers are burdened with restrictions on allowable pollutants that their vehicles can introduce into the atmosphere. Compliance with the burdens is costly. And the cost of compliance is typically passed on to the consumer.

Entire industries have developed around the production of equipment that cleans the outside air before allowing it into buildings. Traditional heating and cooling product manufacturers typically include air filtration in their products. Smaller consumer product manufacturers have developed a variety of air cleaning products that a consumer can purchase inexpensively to filter the air within their homes and offices.

Current approaches control the flow of pollutants into the air after the air is polluted by combustion or by a manufacturing process. Other current approaches control the flow of pollutants into our buildings, homes and offices. Also present approaches filter the air that is already contained in our buildings, homes or offices and reintroduces the filtered air back into our buildings, homes and offices. Also current approaches typically consume energy specifically to perform the filtering process.

The invention was made with the above discussed problems in mind and aims to address the related problems.

### SUMMARY

According to one aspect of the inventions there is provided a filter for removing pollutants from the atmosphere wherein the filter is connected to a vehicle. The filter comprising: a filter material for removing pollutants from the atmosphere to create filtered air; and a housing for: holding the filter material; channeling air from the atmosphere through the filter material; channeling filtered air back into the atmosphere; and providing attachment means for attaching the filter to the vehicle.

According to another aspect of the invention there is provided a method for removing the pollutants from the atmosphere comprising: connecting a filter to a vehicle. The filter comprising: a filter material for removing pollutants from the atmosphere to create filtered air; and a housing connected to the vehicle for: holding the filter material; channeling air from the atmosphere through the filter material; channeling filtered air back into the atmosphere; and providing attachment means for attaching the filter to the vehicle. The method also comprising operating the vehicle such that air from the atmosphere flows through the filter.

The above and further features of the invention are set forth with particularity in the appended claims and together with advantages thereof will become clearer from consideration of the following detailed description of an exemplary embodiment of the invention given with reference to the accompanying drawings.

### BRIEF DESCRIPTION OF THE DRAWINGS

In the drawings:

FIG. 1 is a drawing of a filter attached to a vehicle;

FIG. 2 is a drawing of a filter attached in an alternate mounting location on a vehicle;

FIG. 3 is a drawing of a filter incorporated into a vehicle during the vehicles manufacture;

FIG. 4A is a cross section diagram of a filter;

FIG. 4B is an alternate cross section diagram of a filter showing a filter element location;

FIG. 4C is a cross section diagram of a filter showing multiple filter element locations;

FIG. 4D is a cross section diagram of a filter showing multiple filter element locations, multiple filter materials, multiple filter element designs and multiple filter dimensions;

FIG. 4E is a cross section diagram of a filter with a flow enhancer;

FIG. 4F is a cross section diagram of a filter with enhanced outer dimensions.

### DETAILED DESCRIPTION

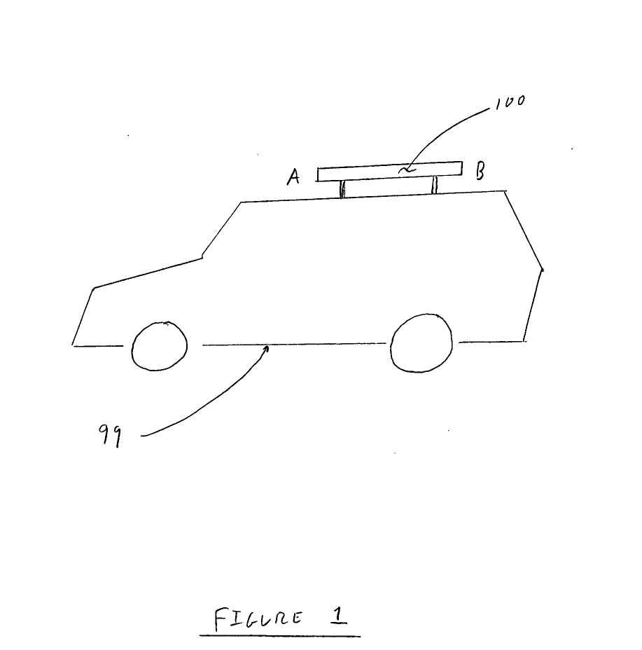

Turning now to FIG. 1 of the accompanying drawings there is shown a filter 100 that is attached to a vehicle 99. Air enters the filter 100 through entrance A when the vehicle 99 is in motion. After filtering, the filtered air exits the filter through exit B. Filter 100 is attached to the vehicle 99 longitudinally so that when the vehicle is in motion air flows through the filter 100 appropriately.

The term driver is used to refer any one of the driver, consumer, vehicle operator, filter owner or user.

The characteristics of air flow over a vehicle are very complex. Factors to consider when choosing a position for the filter comprise: air pressure changes as the air flows over the vehicle; availability of space for the filter and the desire for an esthetic appearance on the vehicle.

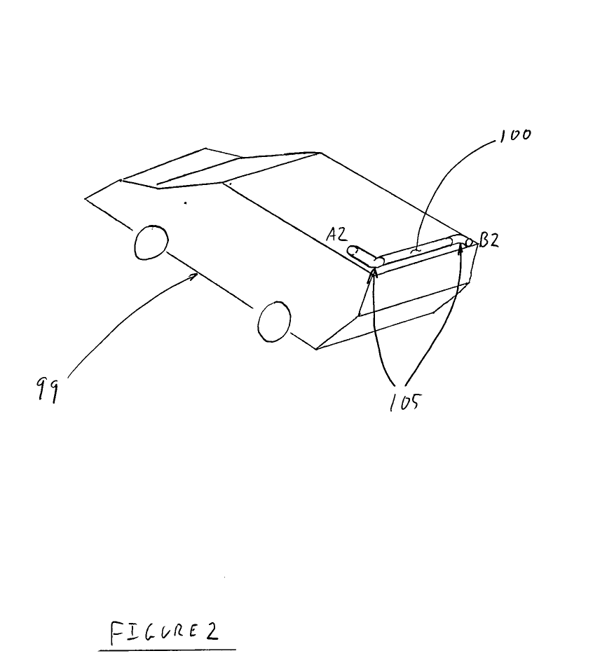

In FIG. 2 of the accompanying drawings there is shown an alternate mounting position for filter 100. Filter 100 is mounted horizontally in relation to the vehicle 99 line of motion. Angular tubing 105 is used to change the direction of the entrance A2 and exit B2 of filter 100.

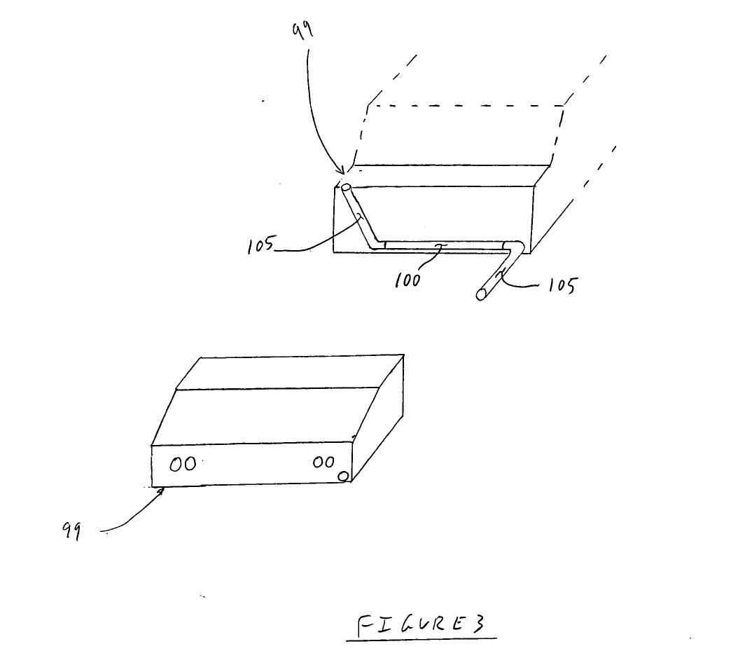

In FIG. 3 of the accompanying drawings there is shown another alternative where the filter 100 has been incorporated into the vehicle 99 during vehicle 99 manufacture. In this drawing a portion of the front of the vehicle 99 is shown removed to more clearly indicate the location of the filter 100 and the angular tubing 105

It will be apparent to those of appropriate skill that other locations, angles in relation to the axis of motion of the vehicle and appropriate routing of the entering and exiting air can be used.

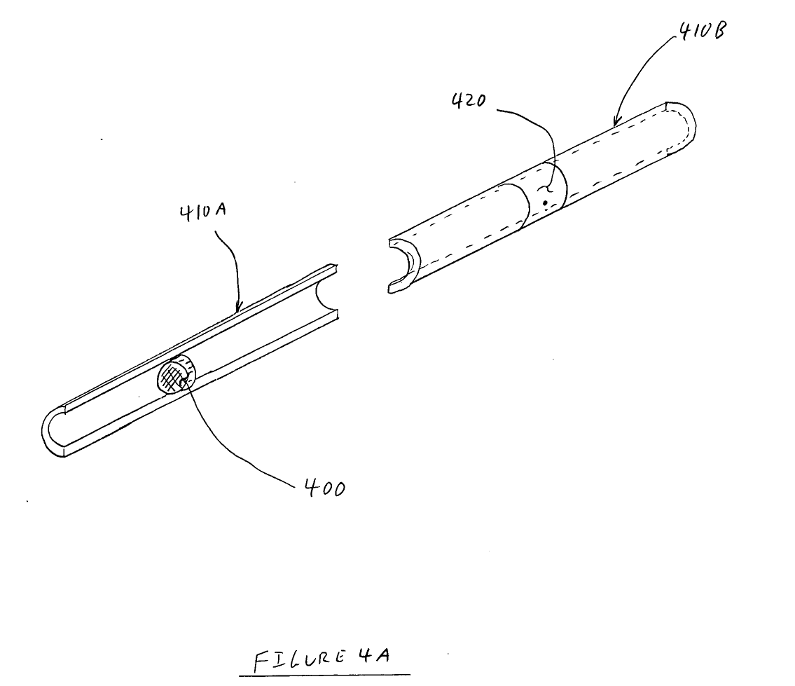

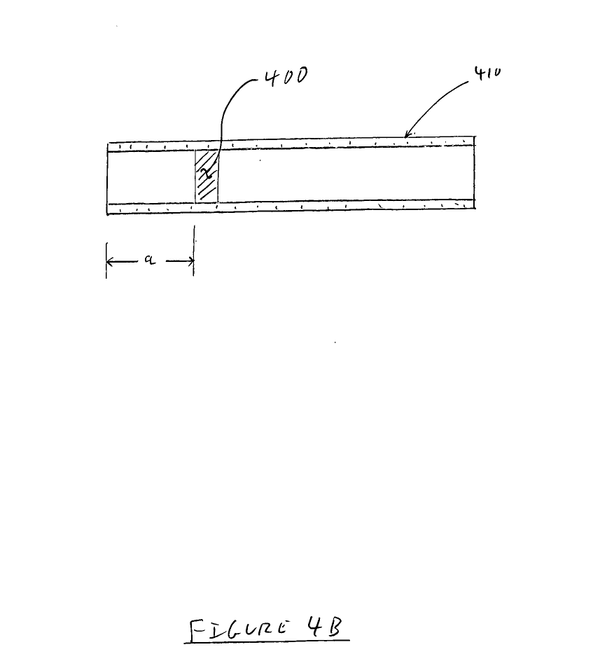

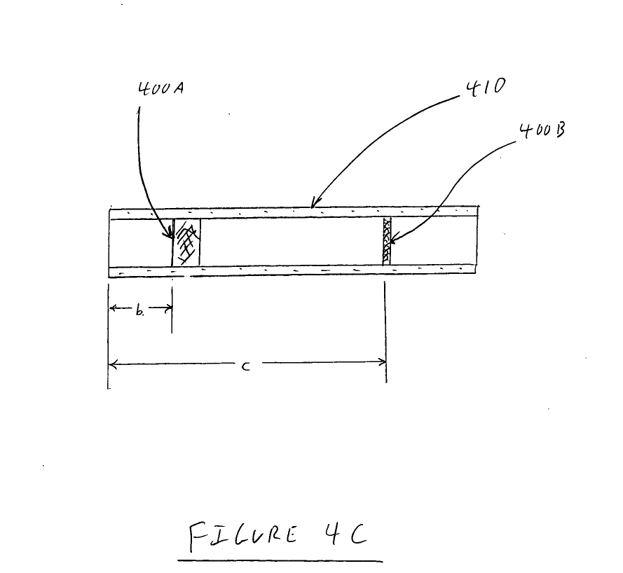

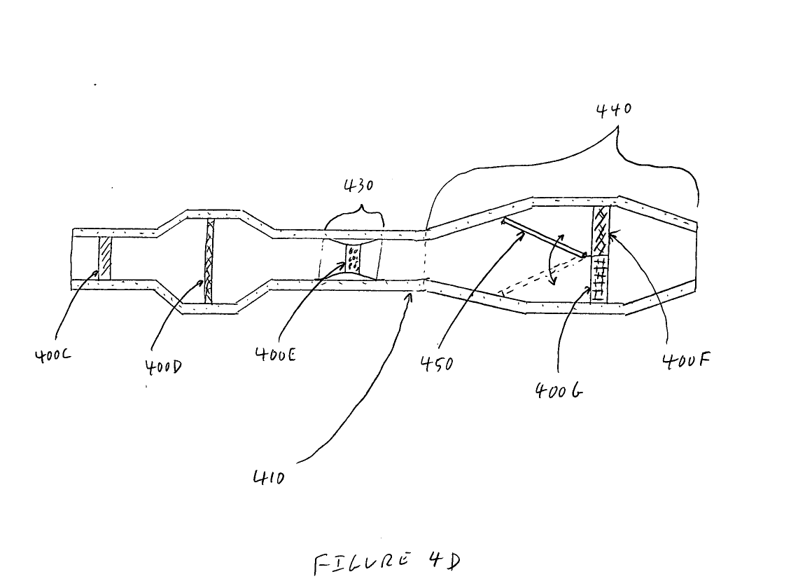

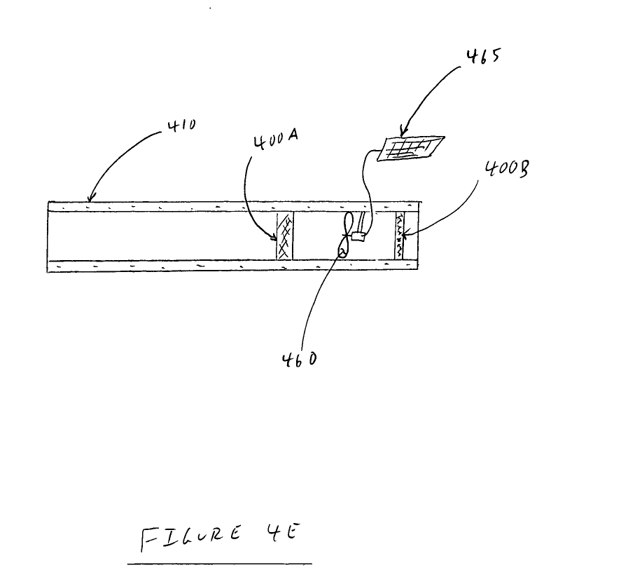

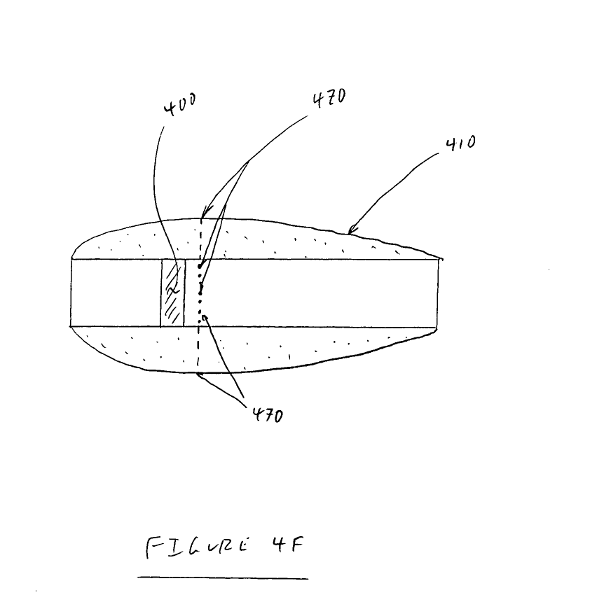

In FIGS. 4A, B, C, D, E of the accompanying drawings there is shown a cut-away view of filter 100. In FIG. 4A filter housing 410A is shown as half a cylinder. The filter housing during operation would be a complete cylinder incorporating filter housing 410A and 410B. Filter housing 410B is shown with an access door 420. There is also shown filter material 400.

Filter housing 410A and 410B combined are referred to as filter housing 410.

The dimensions of filter housing 410 are varied as needed. In FIG. 4A the filter housing is shown as a cylinder. Other shapes with other cross sections can be used. It will be apparent to those of appropriate skill that the dimensions of the filter housing 410 and overall filter 100 are variable. The length of the filter as well as the cross sectional dimension and basic cross sectional shapes are variable.

Turning now to FIG. 4B, filter material 400 is located distance <a> from the entrance to the filter housing 410. When the vehicle 99 is in motion, with the filter 100 attached, air flows through the filter. The pressure of the air flowing through the filter 100 varies along the length of the filter housing 410. The distance <a> is selected so as to place the filter material 400 at a point in the filter housing 410 where air pressure is appropriate for the filter material.

The air pressure also varies inside of filter 100 in relation to the overall length of filter housing 410. Air pressure will also vary in relation to the diameter or cross section area of the filter housing 410. Tubing used to change the direction of the air as it flows through the filter housing 410 will have an effect on the air pressure also.

The side of the filter material 400 where air enters is referred to as the face. The side of filter material 400 where the filtered air exits is referred to as the rear. By locating filter material 400 at a point where the face of filter material 400 experiences a higher pressure than the rear of filter material 400 air will be drawn through the filter material 400.

Filter material 400 is provided in a variety of filter material types. The driver typically selects the filter material type. Filter material types vary in relation to the type of pollutant that the filter material type is designed to remove from the air that is passed through or over it.

Filter material types comprise inert material that captures pollutants as the air flow through it, active material that alters the chemical composition of the air as the air passes through it and electrostatic material that enhances the removal of pollutants by applying a charge to the pollutants and then removing the charged pollutants before allowing the air to reenter the atmosphere.

In FIG. 4C of the accompanying drawings there is shown the filter 100 with two sections of filter material 400. It will be apparent to those of appropriate skill that multiple filter material 400 elements can be used and that a variety of filter material types can be used. Filter material 400A is located a distance <b> from the entrance to filter housing 410. The filter material 400A is a filter material type that filters large particles out of the air. Filter material 400A is referred to as a “course” filter material type. Filter material 400B is located a distance <c> from the entrance to filter housing 410. The filter material 400B is to filter material type that filters small particles out of the air. Filter material 400B is referred to as a “fine” filter material type.

The filter 100 dimensions are varied so that air flow is optimized in relation to the type of filtering desired. For a chosen filter material type there are corresponding dimensions of the filter 100 that are desirable.

For example, the filter 100 depicted in FIG. 3 could have a first filter material type close to the entrance of the filter that filters out coarse pollutants. Further into the filter a second filter material type is used to filter out smaller pollutants. Even further into the filter there is a third filter material type that actively changes the chemical composition of the air. Still further into the filter 100 is a fourth filter material type which uses electro static charges to remove pollutants. For each of the filter material types there are desirable air flow characteristics. The filter housing 410 dimensions are varied along the length of the filter 100 so that desirable air flow characteristics for each filter material type are achieved. Since the filter 100 in FIG. 3 is also of the type that is incorporated into a vehicle during the vehicle's manufacture, some of the filter 100 dimensions are varied in relation to vehicle design restrictions.

In FIG. 4D there is shown multiple alternative installations of filter material 400 into filter housing 410. Filter housing 410 varies in diameter in relation to the length of the housing so that filter material of varying diameters and types can be used in the housing. There is shown filter material 400C, 400D, 400E, 400F and 400G. Also in FIG. 4D there is shown a filter element 430 with an insert to reduce the diameter of the cross section for a particular filter material type, filter material 400E without reducing the diameter of the filter housing 410. Alternately there is shown a filter element 440 that allows the driver to select between different material types, 400F and 400G. An air flow divider 450 which is movable so as to divert the flow of air through either filter material 400F or 400G without removing the filter material 400F or 400G.

The filter housing 410 is constructed such that the filter elements are removable, cleanable and replaceable by the driver. The filter housing 410 is constructed in such a way that filter elements may be placed at different positions within the filter housing 410. The filter elements typically have a preferred location within the housing in relation to the type of filtering the element is to perform. This allows the type of filtering to be tailored to the geographic location of the vehicle. It is anticipated that local governments can provide information as to the type of filtering desired for the particular location. By designing the housing such that the filter material 400 can be positioned at various locations within filter housing 410, a filter owner can change the filter material type that is being used without sacrificing optimal positioning of the filter material type. The driver simply removes the old filter material type, selects the appropriate location in the housing for a new filter material type and installs the new filter material type.

In FIG. 4E of the accompanying drawings there is shown filter 100 with two filter material types of filter material 400A and filter material 400B. Also included is a device to force air through the housing when the vehicle is not in motion. There is shown an internal fan 460 powered by a energy source 465. When the vehicle stops internal fan 460 is activated and is powered by energy source 465.

It will be apparent to those of appropriate skill that various sources of power can be used. In FIG. 4E the energy source 465 is represented as a solar panel. Alternate power sources comprise rechargeable battery, vehicle power sources and vehicle battery power.

Using solar energy to force air through the filter when the vehicle 99 is not in motion (or is moving slowly) is an economical approach to continue filtering even though the vehicle 99 is not in motion.

It will be apparent to those of appropriate skill that internal fan 460 can be located in various positions along the length of filter 100 and that more than one fan can be used.

Using the filter 100 while the vehicle is operated such that the vehicle is in motion typically filters the largest volume of air per unit time. However filtering is also accomplished by operating the vehicle in other ways. Other operations of the vehicle 99 comprise: parking the vehicle outside so that natural air currents generated in the atmosphere causes air to flow through the filter 100; supplying vehicle power to the filter 100 so that a flow enhancer such as an internal fan 460 is operating; parking the vehicle 99 so that the filter 100 receives a steady flow of air such as by prevailing winds or breezes and parking the vehicle 99 so that the filter 100 receives a steady flow of air such as is generated by an industrial fan.

In FIG. 4F there is shown a filter with enhanced outer dimensions. The outside dimension of filter housing 410 varies along its length such that air flow speed is changed. In FIG. 4F the air flow speed is increased creating a corresponding reduction in air pressure on the outside of filter housing 410. Bleed holes 470 are arranged around the circumference of the filter 100. The bleed holes connect the region of lower pressure on the outside of filter housing 410 with the inside of the filter housing 410. The bleed holes are positioned such that a pressure differential is created between the face of filter material 400 and the rear of filter material 400. Pressure is greater at the face of filter material 400 than at the rear of filter material 400. The pressure differential enhances the flow of the air through the filter material 410.

Having thus described the invention by reference to a preferred embodiment it is to be well understood that the embodiment in question is exemplary only and that modifications and variations such as will occur to those possessed of appropriate knowledge and skills may be made without departure from the spirit and scope of the invention as set forth in the appended claims and equivalents thereof.

1. A filter for removing pollutants from the atmosphere wherein the filter is connected to a vehicle, the filter comprising:
a filter material for removing pollutants from the atmosphere to create filtered air; and
a housing for:
holding the filter material;
channeling air from the atmosphere through the filter material;
channeling filtered air back into the atmosphere; and
providing attachment means for attaching the filter to the vehicle.

2. The filter of claim 1 wherein the filter comprises more than one filter material.

3. The filter of claim 2 wherein there is more than one filter material type.

4. The filter of claim 3 wherein the filter housing internal dimensions vary as appropriate for each material type.

5. The filter of claim 1 wherein the filter housing external dimensions vary along the length of the filter housing.

6. The filter of claim 5 wherein the filter housing outer dimensions vary such that a region of lower air pressure is created on the outside of the filter housing.

7. The filter of claim 5 wherein the region of low air pressure on the outside of the filter housing is connected to the inside of the filter housing by bleed air holes.

8. The filter of claim 1 further comprising:
a fan for enhancing the flow of air through the filter.

9. The filter of claim 8 wherein there is more than one fan.

10. The filter of claim 1 wherein there is provided an access door, the access door providing access to the filter material.

11. The filter of claim 1 further comprising:
a filter element for:
holding the filter material; and
providing a connection means between the filter material and the filter housing.

12. The filter of claim 11 wherein the filter element reduces the inside dimension of the filter housing.

13. The filter of claim 11 wherein there is more than one filter material in a filter element, the filter element comprising:
a flow divider for diverting the flow of air so that the driver can select one or more of the filter elements.

14. A method for removing the pollutants from the atmosphere comprising:
connecting a filter to a vehicle, the filter comprising:
a filter material for removing pollutants from the atmosphere to create filtered air; and
a housing connected to the vehicle for:
holding the filter material;
channeling air from the atmosphere through the filter material;
channeling filtered air back into the atmosphere; and
providing attachment means for attaching the filter to the vehicle; and
operating the vehicle such that air from the atmosphere flows through the filter.

15. A means for removing the pollutants from the atmosphere comprising:
means for connecting a filter to a vehicle, the filter comprising:
a filter material for removing pollutants from the atmosphere to create filtered air; and
a housing connected to the vehicle for:
holding the filter material;
channeling air from the atmosphere through the filter material;
channeling filtered air back into the atmosphere; and
providing attachment means for attaching the filter to the vehicle; and
means for operating the vehicle such that air from the atmosphere flows through the filter.
